(19) United States
(12) Patent Application Publication
(10) Pub. No.: US 2016/0344855 A1
(43) Pub. Date: Nov. 24, 2016

(54) UNLOCKING SYSTEM OF PORTABLE ELECTRONIC DEVICE AND METHOD THEREOF

(71) Applicant: HON HAI PRECISION INDUSTRY CO., LTD., New Taipei (TW)

(72) Inventor: HSIANG-EN PENG, New Taipei (TW)

(21) Appl. No.: 14/832,634

(22) Filed: Aug. 21, 2015

(30) Foreign Application Priority Data
May 22, 2015 (TW) 104116579

(51) Int. Cl. H04M 1/673; G06F 3/0488; H04W 12/08; G06F 3/0484

(52) U.S. Cl. CPC H04M 1/673; G06F 3/0484; G06F 3/04883; H04W 12/08

(57) ABSTRACT

A portable electronic device is capable of switching between a locked state and an unlocked state. The portable electronic device includes a touch screen, a storage device, a control module, an identifying module, and a comparison module. The touch screen is black while the portable electronic device in the locked state. The storage device stores unlocking information. The control module controls a display region of the touch screen to form an active region for sensing a touch operation and a non-active region. The identifying module identifies a touch operation on the active region as input information. The comparison module compares the input information and the unlocking information. When the input information is identical to the unlocking information, the comparison module switches the portable electronic device to be unlocked.

### CROSS-REFERENCE TO RELATED APPLICATIONS

This application claims priority to Taiwanese Patent Application No. 104116579 filed on May 22, 2015, the contents of which are incorporated by reference herein.

### FIELD

The subject matter herein generally relates to an unlocking system of a portable electronic device.

### BACKGROUND

A portable electronic device can switch between a locked state and an unlocked state. A common unlocking technique for the portable electronic device in the locked state is to input an alpha-numeric pass code using a physical keypad of the electronic device or a virtual keypad displayed on a touch screen of the portable electronic device.

### BRIEF DESCRIPTION OF THE FIGURES

Many aspects of the embodiments can be better understood with reference to the following drawings. The components in the drawings are not necessarily drawn to scale, the emphasis instead being placed upon clearly illustrating the principles of the electronic device and writing protection method thereof. Moreover, in the drawings, like reference numerals designate corresponding parts throughout the views.

FIG. 1 is a block diagram of an embodiment of the portable electronic device, the portable electronic device comprises a touch screen.

FIG. 2 is a diagrammatic view of a first embodiment of the portable electronic device of FIG. 1 defining a plurality of active regions on a display region of the touch screen.

FIG. 3 is a diagrammatic view of an embodiment of the portable electronic device of FIG. 2 indicating a touching path for unlocking the portable electronic device.

FIG. 4 is a diagrammatic view of a second embodiment of the portable electronic device of FIG. 1 defining a plurality of active regions on the display region.

FIG. 5 is a diagrammatic view of a third embodiment of the portable electronic device of FIG. 1 defining a plurality of active regions on the display region.

FIG. 6 is a flowchart of an embodiment of the unlocking method for unlocking a portable electronic device.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented. The term “module” refers to logic embodied in computing or firmware, or to a collection of software instructions, written in a programming language, such as, Java, C, or assembly. One or more software instructions in the modules can be embedded in firmware, such as in an erasable programmable read only memory (EPROM). The modules described herein can be implemented as either software and/or computing modules and can be stored in any type of non-transitory computer-readable medium or other storage device. Some non-limiting examples of non-transitory computer-readable media include CDs, DVDs, BLU-RAY™, flash memory, and hard disk drives. The term “comprising” means “including, but not necessarily limited to”; it specifically indicates open-ended inclusion or membership in a so-described combination, group, series, and the like.

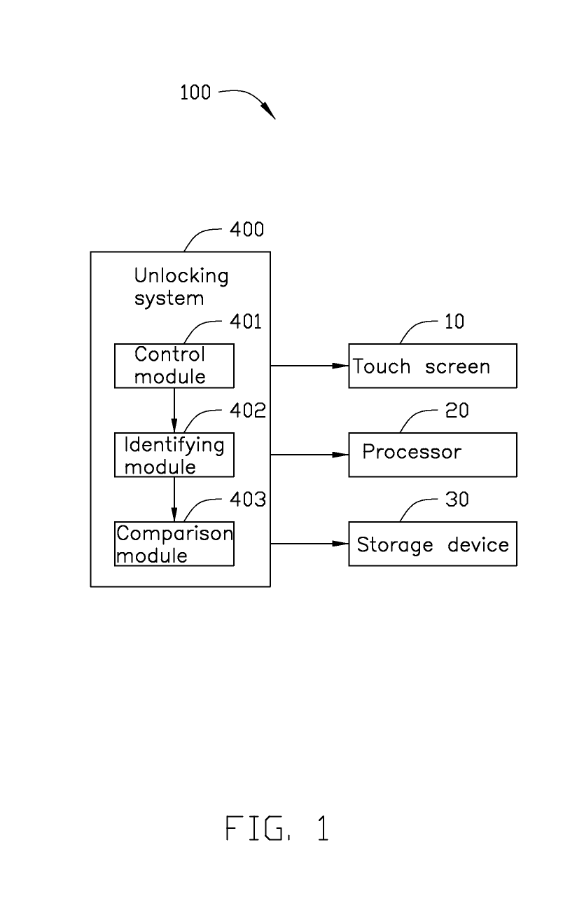

FIG. 1 illustrates an embodiment of a portable electronic device 100. The portable electronic device 100 displays images, and is capable of switching between a locked state and an unlocked state. In at least one embodiment, the portable electronic device 100 is a mobile phone. In other embodiments, the portable electronic device 100 can be a tablet computer or a personal digital assistant (PDA). The unlocking system 400 includes a control module 401, and identifying module 402, and a comparison module 403. The modules 401-403 can include computerized instructions in the form of one or more computer-readable programs that can be stored in a non-transitory computer-readable medium, such as the storage device 30, and be executed by the at least one processor 20 of the portable electronic device 100.

The portable electronic device 100 includes a touch screen 10, at least one processor 20, storage 30, and an unlocking system 400, which are communicating with each other wired or wirelessly.

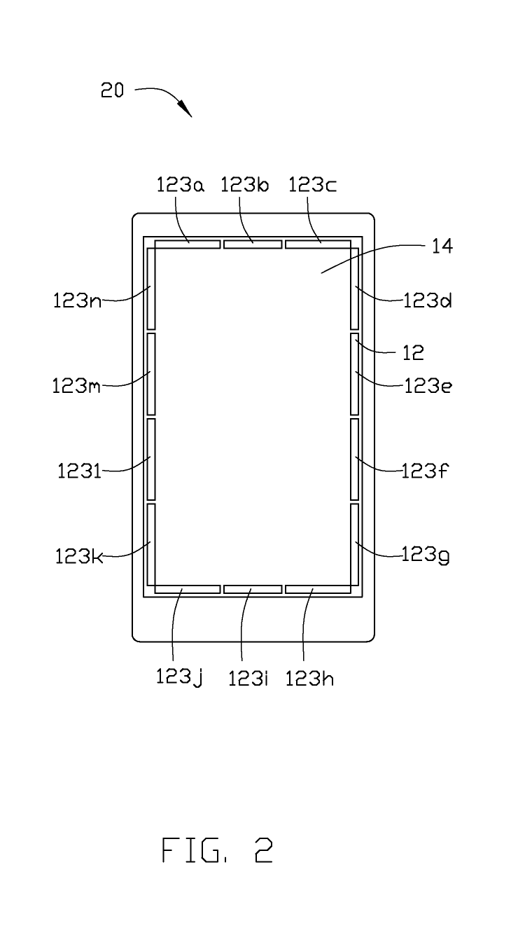

FIG. 2 illustrates the embodiment of the touch screen 10 with a display region. The touch screen 10 is illuminated while the portable electronic device 100 is in the unlocked state, and the display is black while the portable electronic device 100 is in the locked state. A display region of the touch screen 10 forms an active region 12 and a non-active region 14 when the portable electronic device 100 is in the locked state. The active region 12 is substantially a rectangular frame shaped, and is enabled to sense a touch operation. The active region 12 includes a plurality of touch regions 123a-123n. The touch regions 123a-123n are spaced from each other, and in a rectangular arrangement surrounding the non-active region 14. A number of the touch regions 123a-123n is an even number, and is larger than a predetermined value. A number of the touch regions 123a-123n arranged in a line along a first direction is more than a number of the touch regions 123a-123n arranged in a line along a second direction perpendicular to the first direction. The non-active region 14 is disabled and cannot identify any touch operation and is black. In at least one embodiment, the first direction is parallel widthwise of the portable electronic device 100, and the second direction is parallel lengthwise of the portable electronic device 100. The number difference of the touch regions 123a-123n arranged in a line along the first direction and the touch regions 123a-123n arranged in a line along the second direction is 1. The predetermined value is 6.

The at least one processor 20 executes one or more computerized codes and other applications of the portable electronic device 100 to provide functions of the portable electronic device 100. The storage device 30 stores unlocking information with a plurality of specified touch regions being touched in a specified touch sequence. The storage device 30 is a non-transitory computer-readable medium and can be an internal storage device, such as a random access memory (RAM) for temporary storage of information, and/or a read only memory (ROM) for permanent storage of information. The storage device 30 can also be an external storage device, such as an external hard disk, a storage card, or a data storage medium. In at least one embodiment, the first specified touch region is the same as the last specified touch region. In other embodiments, the first specified touch region is different from the last specified touch region.

The unlocking system 400 identifies a touch operation on the active region 12 and a touch sequence of the touch operation as input information, and compares the input information with the predetermined unlocking information. When the input information is identical to the unlocking information, the unlocking system 400 switches the portable electronic device 100 into the unlocked state. In at least one embodiment, the unlocking operation can unlock a display screen of the portable electronic device 100, a keyboard of the portable electronic device 100, or an encryption file of the portable electronic device 100.

The control module 401 controls a display region of the touch screen 10 to form an active region 12 with a plurality of touch regions 123a-123n and a non-active region 14 when the portable electronic device 100 is in the locked state.

The identifying module 402 identifies a touch operation on the active region 12 and a touch sequence of the touch operation as input information. In at least one embodiment, the identifying module 402 identifies the touch regions being touched, and a touch sequence of the identified touch regions.

The comparison module 403 compares the input information with the unlocking information. When the input information is identical to the unlocking information, the comparison module 403 switches the portable electronic device 100 into the unlocked state for displaying a main interface on the touch screen 10. The comparison module 403 orderly compares the identified touch regions with the specified touch regions. The comparison module 403 further controls a flash of the identified touch region when the identified touch region is identical to the specified touch region. In at least one embodiment, the lasting time of the flash of the indentified touch region can be adjusted by a user. The comparison module 403 orderly compares the identified touch regions in a touch sequence with the specified touch regions in a specified touch sequence. In other embodiments, the comparison module 403 further controls the portable electronic device 100 to vibrate when the identified touch region is identical to the specified touch region.

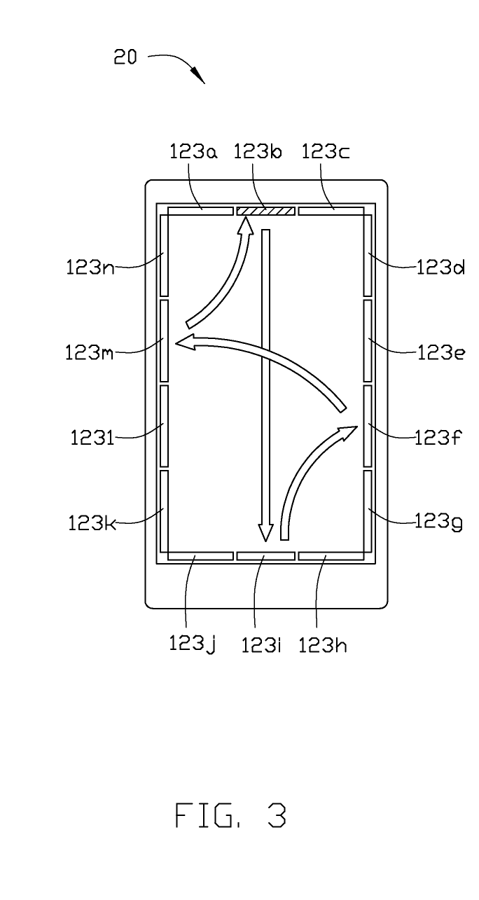

FIG. 3 illustrates the touch screen 10 indicating a touch path for unlocking the portable electronic device 100. The touch regions 123a-123c and the touch regions 123h-123j are symmetrically arranged opposite to each other along the first direction, the touch regions 123d-123g and the touch regions 123k-123n are symmetrically arranged opposite to each other along the second direction. The touch regions 123b, 123i, 123f, 123m, 123b are touched in order. When the touch region 123b being touched first is identical to the specified touch region, the touch region 123b is flashed.

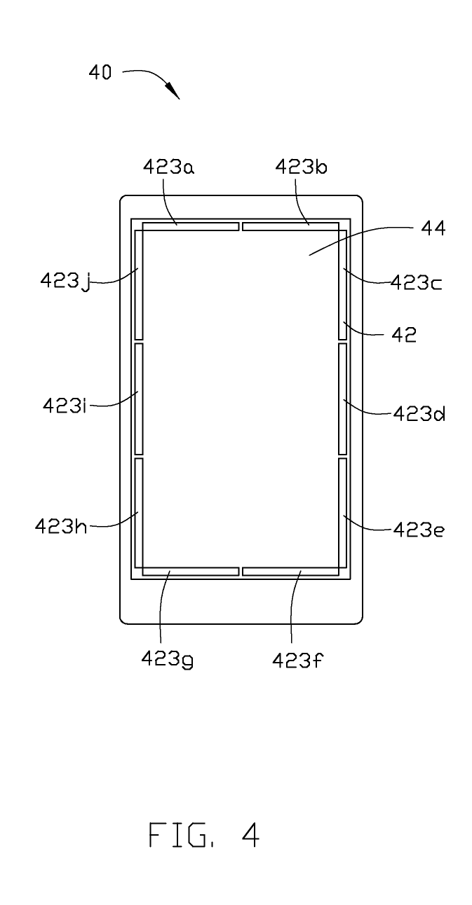

FIG. 4 illustrates a second embodiment of the touch screen 40. A display region of the touch screen 40 forms an active region 42 and a non-active region 44 when the portable electronic device 100 is in the locked state. The active region 42 is substantially a rectangular frame shaped, and is enabled for identifying a touch operation. The active region 42 includes ten touch regions 423a-423j. The touch regions 423a-423j are spaced from each other, and in a rectangular arrangement surrounding the non-active region 44. The touch regions 423a-423b and the touch regions 423f-423g are symmetrically arranged opposite to each other along the first direction, the touch regions 423c-423e and the touch regions 423h-423j are symmetrically arranged opposite to each other along the second direction. The non-active region 44 is disabled and cannot identify any touch operation. The non-active region 44 is black. In at least one embodiment, the first direction is parallel widthwise of the portable electronic device 100, and the second direction is parallel lengthwise of the portable electronic device 100.

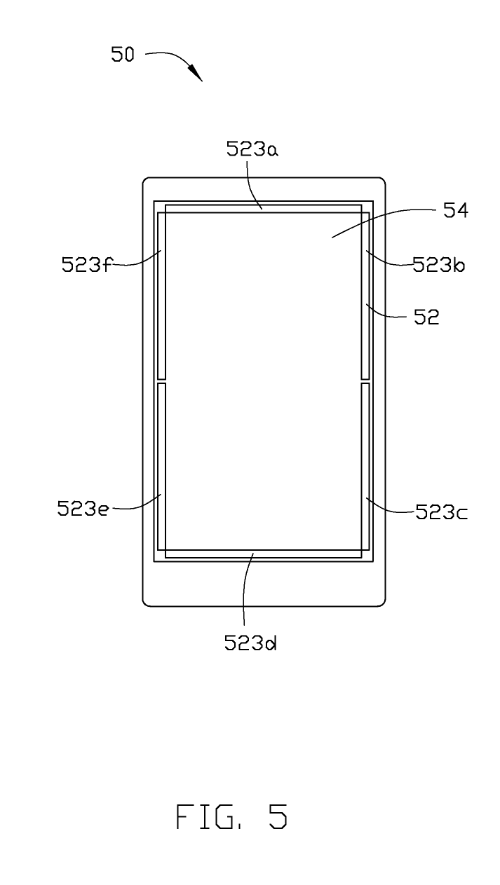

FIG. 5 illustrates a third embodiment of the touch screen 50. A display region of the touch screen 50 forms an active region 52 and a non-active region 54 when the portable electronic device 100 is in the locked state. The active region 52 is substantially a rectangular frame shaped, and is enabled for identifying a touch operation. The active region 52 includes ten touch regions 523a-523f. The touch regions 523a-523f are spaced from each other, and in a rectangular arrangement surrounding the non-active region 54. The touch regions 523a and the touch regions 523d are symmetrically arranged opposite to each other along the first direction, the touch regions 523b-523c and the touch regions 523e-523f are symmetrically arranged opposite to each other along the second direction. The non-active region 54 is disabled and cannot sense touch operations. The non-active region 54 is black. In at least one embodiment, the first direction is parallel widthwise of the portable electronic device 100, and the second direction is parallel lengthwise of the portable electronic device 100.

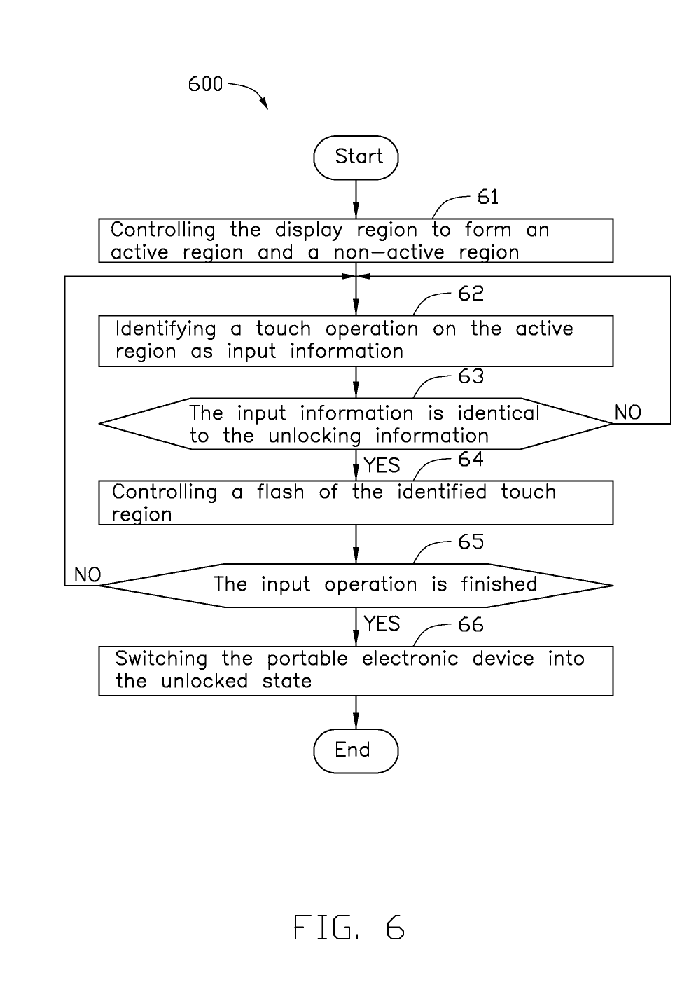

FIG. 6 illustrates a flowchart of an embodiment of an unlocking method 600 for the portable electronic device 100. The unlocking method 600 is provided by way of example, as there are a variety of ways to carry out the volume adjusting method. The unlocking method 600 described below can be carried out using the configurations illustrated in FIGS. 1-3, for example, and various elements of these figures are referenced in explaining the unlocking method 600. Each block shown in FIG. 6 represents one or more processes, methods or subroutines, carried out in the method 600. Furthermore, the order of blocks is illustrative only and the order of the blocks can change according to the present disclosure. Additional blocks can be added or blocks can be removed, without departing from this disclosure. The volume adjusting method 600 can begin at block 61.

At block 61, the control module 401 controls a display region of the touch screen 10 to form an active region 12 and a non-active region 14. The active region 12 is substantially a rectangular frame shaped, and is enabled for sensing a touch operation. The active region 12 includes a plurality of touch regions 123. The touch regions 123 are spaced from each other, and in a rectangular arrangement surrounding the non-active region 14. A number of the touch regions 123 is an even number, and is larger than a predetermined value. A number of the touch regions 123 arranged in a line along a first direction is more than a number of the touch regions 123 arranged in a line along a second direction perpendicular to the first direction. The non-active region 14 is disabled and cannot identify any touch operation. The non-active region 14 is black.

At block 62, the identifying module 402 identifies a touch operation on the active region 12 as input information. In at least one embodiment, the identifying module 402 identifies the touch regions 123 being touched, and a touch sequence of the identified touch regions 123.

At block 63, the comparison module 403 compares the input information and the unlocking information. When the input information is identical to the unlocking information, the procedure goes to block 64. When the input information is different from the unlocking information, the procedure goes to block 62. In at least one embodiment, the comparison module 403 orderly compares the identified touch regions 123 in a touch sequence with the specified touch regions in a specified touch sequence.

At block 64, the comparison module 403 controls a flash of the identified touch region 123 when the identified touch region 123 is identical to the specified touch region. In at least one embodiment, the lasting time of the flash of the indentified touch region 123 can be adjusted by a user. In other embodiments, the comparison module 403 further controls the portable electronic device 100 to vibrate when the identified touch region 123 is identical to the specified touch region.

At block 65, the comparison module 403 determines whether the input operation is finished. When the input operation is finished, the procedure goes to block 66. When the input operation is not finished, the procedure goes to block 62.

At block 66, the comparison module 403 switches the portable electronic device 100 into the unlocked state for displaying a main interface.

In use, while inputting information for unlocking the portable electronic device, the touch screen remains black. Therefore, a privacy of the portable electronic device is improved, and the power of the portable electronic device is saved.

While various embodiments have been described, the disclosure is not to be limited thereto. Various modifications and similar arrangements (as would be apparent to those skilled in the art) are also intended to fall within this disclosure. The scope of the appended claims should be accorded the broadest interpretation so as to encompass at least all such modifications and similar arrangements.

What is claimed is:

1. A portable electronic device capable of switching between a locked state and an unlocked state, the portable electronic device comprising:
a touch screen capable of being illuminated while the portable electronic device is in the unlocked state and capable of being black while the portable electronic device in the locked state;
a storage device configured to store unlocking information;
a control module configured to control a display region of the touch screen to form an active region, for sensing a touch operation, and to form a non-active region;
an identifying module configured to identify a touch operation on the active region as input information; and
a comparison module configured to compare the input information and the unlocking information;
wherein the comparison module is configured such that when the input information is identical to the unlocking information, the comparison module controls the portable electronic device to switch into the unlocked state.

2. The portable electronic device of claim 1, wherein the active region comprises a plurality of touch regions; the touch regions are spaced from each other, and in a rectangular arrangement surrounding the non-active region; the identifying module identifies the touch region being touched.

3. The portable electronic device of claim 2, wherein a number of the touch regions is an even number, and is larger than a predetermined value.

4. The portable electronic device of claim 2, wherein a number of the touch regions arranged in a line along a first direction is more than a number of the touch region arranged in a line along a second direction perpendicular to the first direction.

5. The portable electronic device of claim 4, wherein the number difference of the touch regions arranged in a line along the first direction and the touch regions arranged in a line along the second direction is 1.

6. The portable electronic device of claim 2, wherein the unlocking information comprises a plurality of specified touch region in a specified touching sequence; the comparison module orderly compares the identified touch regions in a touching sequence with the specified touch regions in a specified touching sequence; the comparison module further controls the identified touch region to be flashed when the identified touch region is identical to the specified touch region.

7. The portable electronic device of claim 6, wherein the first specified touch region is the same as the last specified touch region.

8. A unlocking method applied to a portable electronic device; the portable electronic device capable of switching between a locked state and an unlocked state;
the portable electronic device comprising a touch screen; the unlocking method comprising:
controlling a display region of the touch screen being black to form an active region for sensing a touch operation and a non-active region when the portable electronic device in the locked state;
identifying a touch operation on the active region as input information;
comparing the input information with unlocking information; and
switching the portable electronic device into the unlocked state when the input information is identical to the unlocking information.

9. The method of claim 8, wherein the active region comprises a plurality of touch regions; the touch regions are spaced from each other, and in a rectangular arrangement surrounding the non-active region; the step of identifying a touch operation on the active region as input information, the method further comprising:
identifying the touch region being touched.

10. The method of claim 9, wherein the unlocking information comprises a plurality of specified touch region in a specified sequence; after the step of comparing the input information with unlocking information, the method further comprising:
controlling the identified touch region to be flashed when the identified touch region is identical to the specified touch region.

11. The method of claim 9, wherein before the step of switching the portable electronic device into the unlocked state, the method further comprising:
determining whether the input operation is finished; and
switching the portable electronic device into the unlocked state when the input operation is finished.

12. The method of claim 9, wherein a number of the touch regions is an even number, and is larger than a predetermined value.

13. The method of claim 9, wherein a number of the touch regions arranged in a line along a first direction is more than a number of the touch region arranged in a line along a second direction perpendicular to the first direction.

14. The method of claim 13, wherein the number difference of the touch regions arranged in a line along the first direction and the touch regions arranged in a line along the second direction is 1.
